(19) United States
(12) Patent Application Publication
(10) Pub. No.: US 2002/0059387 A1
(43) Pub. Date: May 16, 2002

(54) Method and apparatus for identifying user characteristics and device characteristics using a communication network

(76) Inventor: Robert L. Wolfe, New Rochelle, NY (US)

Correspondence Address: IP Administrator, Gunster, Yoakley & Stewart, Suite 1400, 500 East Broward Blvd., Ft. Lauderdale, FL, 33394, US

(21) Appl. No.: 09/963,146

(22) Filed: Sep. 25, 2001

Related U.S. Application Data
(60) Provisional application No. 60/235,284, filed on Sep. 26, 2000.

(51) Int. Cl. G06F 17/60

(52) U.S. Cl. 709/206; 709/224

(57) ABSTRACT

An apparatus and method for identifying a class of components and a user or particular device using an essentially unique identifier so that particularized content such as messages, advertisements or other information based on the user's characteristics and/or device characteristics can be determined.

### BACKGROUND

Communication networks, in particular global communication networks such as the Internet and interactive cable, possess an ability to deliver information tailored to individuals. However, this ability has been focused mainly on the computer desktop as the primary device through which the individual user accesses the information network. More recently, mobile devices such as personal digital assistants (PDAs) and personal communication system (PCS) telephones have permitted access to the network predominantly for use outside of the home. Even more recently it has been recognized that access to the network would be useful if made available within the home through devices other than the personal computer.

Ultimately, it is apparent that various electrical devices can benefit from access to a global information network. For example, it would be useful for the user's bedside clock radio to be able to access the network to deliver information (data content) pertinent to the individual and as selected by him/her. For example, a person might wish to pre-set the radio alarm to delay if traffic conditions indicated such delay would be appropriate. It might also be desirable to be able to configure the device to provide business information of most interest to the individual at the time of awakening or to provide an advertisement targeted to the user and the device being used by him or her.

If such home devices are to be connected within the home to the communication network and if the correct data is to be delivered to the correct device, it is necessary that the network be able to identify both the nature of the device and the particular individual device so that the appropriate data may be delivered to the appropriate device. It is likewise necessary to provide such identification to a central processing unit connected to an information network in order for the data to be obtained and delivered to the appropriate device.

In addition to the need to have access to an information network, such devices must be able to have constant access to the network in order to maximize their usefulness. Today such “always on” access is provided by means of special high speed telephone lines and cable television modems. In order to better serve such always on devices as well as devices which may contact an information network on an un-attended basis, each device connected to an information network must still be uniquely identifiable to the network so that the appropriate information may be obtained from the network and delivered to the uniquely identified device.

Today, the primary method of identifying a device connected to a network is by assigning to the device a unique identifier or address. The nature of such identification, however, is often temporary, such address being regularly re-used as sessions are ended. Generally, such addresses do not carry with them any information about the device to which it refers or the individual user of the device. It should be noted, however, that within certain networks, the address may be combined for communications purposes with certain other data whose purpose is to further identify the nature of the device. If such device is a personal computer, such device may also deliver information setting forth requests of the user along with the address to which a response should be sent. Although an address may be accompanied by a request of the user, there is currently no known means by which both the nature of the device represented by the address and information sought by the user may be efficiently combined in order to provide a user with desired information in a form necessarily useable by the application device without significant computer programming intervention or individual intervention.

In order to better serve devices within the home, the network within the home should have access to the global information network on a constant “always on” basis or on an unattended basis and each device connected to the system must still be uniquely identifiable to the network so that the appropriate information may be obtained from the network and delivered to the uniquely identified device.

If devices such as those described above are to be accepted by consumers, the added functionality must be provided at the lowest possible cost. The lowest possible cost is only obtainable if the device can be inexpensively mass produced. Mass production may require that each device be identical in order to limit cost of production. It is therefore desirable to provide a common device identifier for all devices of a particular type or one or more designated subtypes which indicates the nature of the device and its capabilities to the network. In this fashion, less expensive mass production is made possible by permitting all devices, such as all clock radios or a particular subset of clock radios to be manufactured without individual differentiation.

If all devices of the same or similar nature are to have a common identifier it is desirable to have an apparatus and method by which each individual networked device may be identified uniquely so that the appropriate data is delivered to the correct individual device.

By uniquely identifying the networked device and user of the device, messages or advertisements targeted to the user, i.e., content selected based upon a matching of one or more advertising criterion to the user's demographic and personal profile are enabled. Methods and systems for providing targeted advertisements are known. For example U.S. Pat. Nos., 5,931,901, 6,038,591, and 6,161,142, each incorporated by reference in their entirety herein are directed toward sequentially interleaving targeted advertisements with a desired content stream. It is also desirable to have an apparatus and method which can simplify the process of targeting advertisements by minimizing the interaction between the user and the system, i.e., minimizing the need for the user to establish and revise profiles for each type of networked device.

Although portable programmable devices which are used for identification are known such as a credit card having a magnetic strip or other memory device used to store a user's name, personal identification code, etc., or to provide permissions such as access cards, it is desirable to have inexpensive, portable, easily programmable devices which store additional personal details about the user. For example, it is desirable to have a portable programmable device which is programmed, i.e., encoded by the user (or a third party for the user) to store one or more criterion corresponding to the user's personal preferences, interests, demographic information, etc.

As noted above, portable programmable devices which are used for identification or access are known. These devices are typically dedicated to use by a particular user, i.e., the credit card holder and a particular device, i.e. credit approval card readers, and can not be used to easily identify one of a group of users or be used in multiple devices. Further, the known devices do not provide any ability for the user to control the information encoded on the card or how such information may be used. It is therefore desirable to have an apparatus and method which can be used to identify a user from a group of potential users in a manner which is unobtrusive to the user and in a manner which allows the user to control whether the user and their personal information is identified to the system. It is also desirable that such methods and apparatus be useable in connection with at least one device.

It is likewise desirable to provide a method by which an individual may interact with a device described which permits the at least one individual to employ the device together with such information about the at least one individual as such individual may determine from time to time in a manner which protects such individual's right to privacy while preserving the benefits of individual identification. Methods of individual profiling, i.e. the gathering of certain personal information such as age, sex, marital status, etc. as well as individual interests are well known. It is likewise obvious to those skilled in the art that an individual can supply voluntarily certain personal information that can be stored by the recipient of such information. Thus, profiling can be accomplished voluntarily e.g. by responding to questions over the Internet which answers can be stored in a database (and the individual or the computer device tracked while on line through the use of small files known as “cookies”) or involuntarily, e.g. through the use of cookies associated with Internet sites at which such cookies are detected anonymously for the purpose of determining generalizations regarding the psychographic identity of the supposed user.

### SUMMARY OF THE INVENTION

According to an aspect of the present invention, a method for using a communication network to determine one or more characteristics is provided in which a device class is identified based on a predetermined common identifier. An individual apparatus associated with a particular user is identified. One or more characteristics based on the identified device class and the individual apparatus are determined.

According to another aspect, an apparatus for identifying one or more characteristics is provided in which a device interface is interconnectable with a user device. An encoded section is electrically coupled to the device interface in which the encoded section has an interface section and an identification component. The interface section is electrically coupled to the device interface and facilitates data communication with a computing device. The identification component is electrically coupled to the interface section and is arranged to identify to the computing device at least one of a device and a user and provide at least one first identification code associated with the identified at least one of the device and the user to the computing device. The first identification code is evaluatable to determine one or more characteristics.

According to still another aspect, an apparatus for identifying one or more characteristics is provided which has a base unit and an identification component in data communication with the base unit. The identification component is arranged to identify at least one of a device and a user and provide a first identification code associated with the identified at least one of the device and the user to the base unit. The first identification code is evaluatable to determine one or more characteristics.

### BRIEF DESCRIPTION OF THE DRAWING FIGURES

For the purpose of illustrating the invention, there is shown in the drawings a form which is presently preferred, it being understood, however, that the invention is not limited to the precise arrangement and instrumentalities shown;

FIG. 1 is a diagram of an identification apparatus constructed in accordance with the principles of the present invention;

FIG. 2 is a diagram of an encoded section of the identification apparatus constructed in accordance with the principles of the present invention;

FIG. 3 is a diagram of an alternate arrangement of an encoded section of the identification apparatus constructed in accordance with the principles of the present invention;

FIG. 4 is a diagram of a network environment in which an identification apparatus constructed in accordance with the principles of the present invention is used;

FIG. 5 is a diagram of an alternate embodiment of an identification apparatus constructed in accordance with the principles of the present invention;

FIG. 6 is a diagram of another alternate embodiment of an identification apparatus constructed in accordance with the principles of the present invention; and

FIG. 7 is a flow chart of a process to determine a user's characteristics and/or specific device using the embodiments of the present invention.

### DETAILED DESCRIPTION OF THE INVENTION

Initially, it is noted that the terms “targeted content”, “targeted advertisement”, and “targeted message” are used interchangeably throughout and, unless a distinction is made herein to the contrary, reference to audio, and/or video and/or audio/video on television and/or textual content selected based on one or more of an identified user, an identified user's preferences and/or an identified type of device capable of providing a particular type of content, i.e. audio-only content, to a user should be read as equivalent.

The present invention advantageously provides that each device type manufactured in accordance with the present invention includes a device identifier or code unique to the type of device and its related capabilities which is the same as each identifier or code of all such devices of the same or similar type and/or capabilities. Rather than separately encoding each individual device with a unique identifier via a code embedded at a particular memory location within the device, thus raising manufacturing costs, the present invention provides a removably attachable apparatus having an effectively unique identifier embedded therein.

The apparatus of the present invention is preferably arranged to read and/or provide the combination of the common device code and the apparatus effectively unique identifier (hereinafter referred to as the “UIQ”), thus creating an effectively unique identification used to identify both the user and the application to the communication network. This reading/provisioning function can be accomplished passively by an external device such as a home electronic device or an access device, described in detail below, which reads the UIQ, or provided actively by programmatic code executed by apparatus of the present invention.

As described above, the present invention is arranged to determine the nature of the applicable device to which it is connected and conveys, to a local or remote central processor, the nature of such device together with the unique identifier of the connector, i.e. the UIQ, in order to permit the central processor to obtain data from the communication network and to deliver the appropriate data to the correct connected device.

It is further contemplated that the present invention can optionally be arranged to include programmatic code which is executed to establish a communication session with a network, thereby obviating the need for the device or an additional access device, to perform this function.

It should be noted that the device of the present invention need not be physically coupled to the computing network. It is contemplated that the device of the present invention can be in wireless communication with the computing network. Further, it is also contemplated that the computing network can be coupled to the communication network, such as the Internet, via a wireless connection.

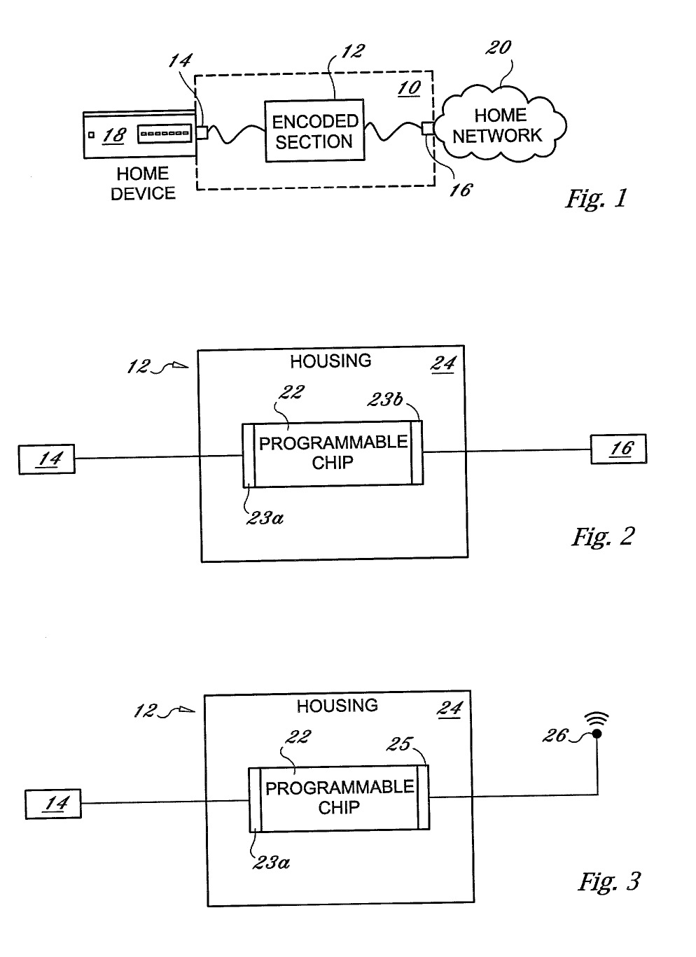

Referring now to the drawing figures in which like reference designators refer to like elements, there is shown in FIG. 1 an identification apparatus 10 constructed in accordance with the principles of the present invention. Identification apparatus 10 includes encoded section 12 which is electrically coupled to a device connector 14 and network connector 16. Device connector 14 is any connector which provides a permanent or removable point of attachment to home device 18. Similarly, network connector 16 is any connector which provides a permanent or removable point of attachment to home network 20. Although the term “home” in “home device” and “home network” is defined to include the user's physical residence, the definition is not limited to such. As used herein, the term “home” is defined as the user's local area. For example, “home network” refers to the network which home device 18 is physically or wireless coupled to, and “home device” refers to the user's local device.

Referring to FIG. 2, encoded section 12 of the preferred embodiment preferably includes a programmable chip 22 and interface sections 23a and 23b, enclosed within housing 24. Programmable chip 22 is encoded with an identification code selected from a group of codes large enough to make it highly unlikely that the same home would contain more than one identification apparatus 10 with the same number. Programmable chip 22 communicates with home device 18 and home network 20 via interface sections 23a and 23b, respectively. Optionally, programmable chip 22 can include embedded controller functionality which allows identification apparatus 10 to actively execute programmatic code as described above. Although the identification code facility is described with respect to a programmable chip, the present invention is not limited to such. It is contemplated that any device or component which provides an effectively unique identification code upon stimulation or access, such as a crystal, can be used.

Interface sections 23a and 23b can be integrated on the same substrate as programmable chip 22 or can be manufactured separately and electrically coupled thereto. Interface section 23a is arranged to format incoming and outgoing data in a format recognizable by home device 18. Similarly, interface section 23b is arranged to format incoming and outgoing data in a format recognizable by home network 20.

Methods for making programmable chips which include embedded identification codes are known. Housing 24 is constructed from plastic or any other suitable protective material.

Referring to FIG. 3., in the case of wireless devices, chip 22 or the identification code itself may be embedded in the same interface hardware 25 used to provide the broadcast carrier which services the wireless network such as a transmitter/receiver 26 for radio, infrared or spread spectrum communication. In other words, like interface sections 23a and 23b described above, the functions provided by chip 22 can be included as part of the wireless communication chip set or can be a separate chip coupled to the wireless communication chip set through the housing of identification apparatus 10.

Although identification apparatus 10 is shown in FIGS. 1-3 as including device connector 14, the present invention is not so limited. It is contemplated that device connector 14 can be replaced with a wireless communication transmitter and receiver as described above with respect to interface hardware 25.

In the preferred embodiment, identification apparatus 10 is coupled to the communication network in a manner such that identification apparatus 10 is always on. Identification apparatus 10 can draw any necessary power via an internal power source such as a battery, from home device 18 or from the home network 20. Further, it is contemplated that identification apparatus 10 can be implemented as a passive non-powered device which is periodically accessed by a device coupled to the home network such as a cable modem, networking hub, router, switching device, etc.

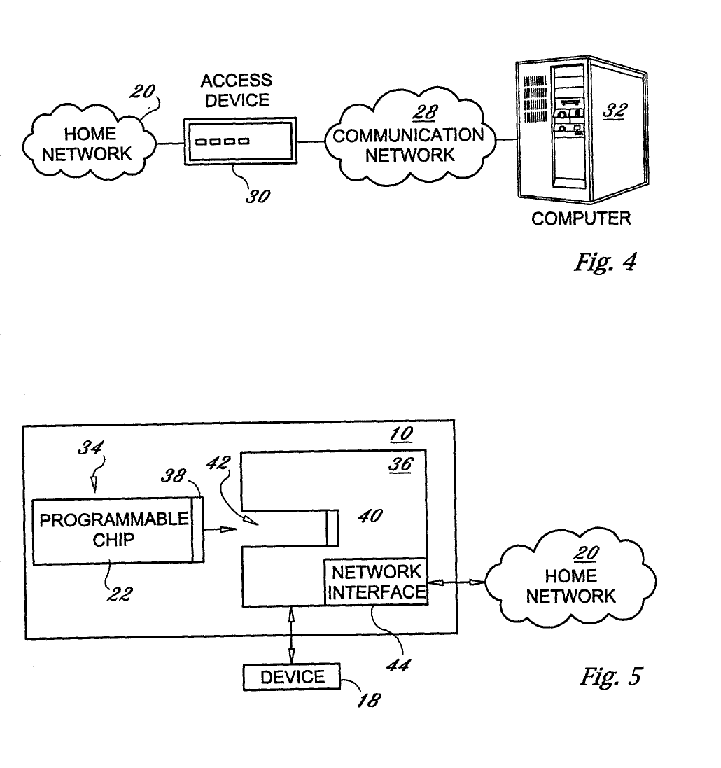

Referring to FIG. 4, home network 20 is coupled to communication network 28 via access device 30. Access device 30 is any device including, but not limited to, a cable modem, networking hub, router, switching device, digital subscriber line (DSL) modem and the like which provides a connection which is substantially always available for use. In use, identification apparatus 10 is accessed directly by computer 32 or other microprocessor-based device coupled to communication network 28 or indirectly via access device 30. Access device 30 can include a wireless transmitter and receiver for wireless communication with a wireless identification apparatus as shown in FIG. 3, or may be included as part of the home device 18. Based on the UIQ, the information corresponding to or requested by the user and the home device 18 is retrieved from computer 32 or some other computing device via communication network 28 and delivered to home device 18.

For example, a clock radio bearing an identifier which indicates that it is a clock radio having certain pre-defined characteristics is coupled to a home network 20 via identification apparatus 10. It is also contemplated that identification apparatus 10 and the device, such as the clock radio, can each be separately coupled to home network 20. Identification apparatus 10 includes a unique identifier capable of communicating to access device 30 both the nature of the device to which it is connected and the unique identifier therein, thus enabling access device 30 to seek and/or deliver the information set by the user to the clock radio without requiring the clock radio to contain a unique identifier of its own. Furthermore, because identification apparatus 10 is anticipated to be highly portable, the same data sought and delivered in the foregoing example could be delivered to another apparatus bearing the same UIQ although physically located hundreds of miles distant from the original home device 18, all without further intervention of the user.

Home device 18 includes an identifier which, when interpreted either by identification apparatus 10, access device 30, communication network 28 or computer 32 indicates the nature of the device e.g. a clock radio or cable set top box. Such identification is substantially identical to all substantially similar devices, e.g. all clock radios or all cable set top boxes of the same manufacturer or having substantially the same operational characteristics. Further, the combination of the identification of home device 18 and the identification code of identification apparatus 10 creates the UIQ which can be interpreted by apparatus 10, access device 30, communication network 28 or the computer 32.

As a further aspect of the invention, it is contemplated that the unique identification capability of identification apparatus 10 can be used in a manner in which the desired data may be delivered to home device 18 along with advertising messages targeted to home device 18 based upon the profiling of the UIQ, i.e. the capabilities of the home device 18 together with the profile of the identification apparatus 10. For example, because identification apparatus 10 can be associated with a user and used to provide desired data, the same identification apparatus 10 can be used to track the user's personal information, likes, dislikes, etc. for storage within identification apparatus 10 (provided identification apparatus 10 includes a storage component) or for storage elsewhere on a computer 32 associated with a communication network 28 so that targeted advertisements can be delivered to the user via home device 18. In the case where home device 18 is a clock radio, television, etc., the identity of content selected by the user can be transmitted to a centralized database and stored for future use in providing targeted advertisements. This is the case regardless of whether the content is received via traditional broadcast reception techniques (AM/FM, etc.) or received digitally via wireless transmission or communication network 28.

Systems and methods for delivering data content and targeted advertisements to a user are described, for example, in U.S. Pat. Nos. 5,931,901 and 6,038,591, and 6,161,142.

An example of an alternate arrangement of identification apparatus 10 is discussed with reference to FIG. 5. As shown in FIG. 1, identification apparatus 10 alternatively has an encoded section 34 and a base unit 36. Encoded section 34 includes programmable chip 22 or other similarly functioning element as discussed above and encoded section interface 38. Encoded section interface 38 is electrically connected to programmable chip 22 and provides an electrical and physical interface for coupling encoded section 34 to base unit 36.

Encoded section 34 can be a credit card-sized device, flash memory card and the like. Methods for producing a miniature credit card or smaller-sized devices having the capacity to store information are known. The miniature nature of encoded section 34 allows a user to conveniently carry section 34 with him or her. Further, the user's characteristics such as preferences can be preprogrammed into encoded section 34 by a vendor and provided to the user or can be programmed by the user or automatically updated using base unit 36 or another unit adapted to program preferences into the encoded section 34. As noted above, methods for encoding data onto a programmable chip are known.

Base unit 36 is arranged to include base interface 40 within receptacle 42. Base interface 40 contains the complimentary physical and electrical components necessary to provide a solid electrical connection with encoded section interface 38. Methods and arrangements for providing electrical and physical connectivity between a removable element such as encoded section 34 and a fixed element such as base unit 36 are known. Base unit 36 also includes network interface 44 used to provide physical and/or logical connectivity with communication network 28.

Base unit 36 can optionally be arranged to provide connectivity to home device 18 to facilitate presentation of the content selected by the user along with targeted content based on the user's characteristics and identified device type. For example, it is contemplated that base unit 36 can be an analog or digital cable television or digital satellite converter which is arranged with a receptacle 42 and base interface 40 for coupling to encoded section 34. As such, base unit 36 and encoded section 34 can provide the UIQ to computer 32 so that based thereon, both the data sought by the user and/or the advertisements appropriate to the user can be delivered to base unit 36, e.g. a television set top box, in the form of audio/video data which can be played thereon. Base unit 36 can therefore provide the audio/video signal to home device 18 which can be a television, stereo, etc., while additionally providing the identification code and/or the common device code to the computer 32 for determination of characteristics corresponding to the user as well as home device 18. This information can be subsequently used to determine a targeted message to display on the home device 18.

Although base unit 36 is described as being a cable television or digital satellite converter, the invention is not so limited. It is contemplated that base unit 36 can take other forms such as a network appliance, cable modem, DSL modem or other device which provides content to home device 18. Further, although FIG. 5 shows the base unit 36 and home device 18 as two separate devices, it is contemplated that base unit 36 and home device 18 can be integrated as a single unit, for example, a network appliance arranged with suitable hardware and programmatic code to receive encoded section 34 and perform the above-described functions.

Further, the present embodiment advantageously provides a method which permits a user to easily identify himself or herself to the network in order to obtain the targeted information. If the user does not wish to identify him or herself to obtain this targeted information, the user simply need not insert encoded section 34 into base 36.

Although the present invention is described above with respect to using encoded section 12 or encoded section 34 to provide only an identification code associated with the user, it is contemplated that either of these encoded sections can be arranged to store particular preference data of the type discussed above for use by computer 32. For example, encoded section 34 can be arranged with a programmable chip 22 having sufficient memory to store specific preference and characteristic data, such as a user's specific interests, e.g., a user who is interested in purchasing an automobile in a particular price range can encode encoded section 34 with data corresponding to this preference such that when encoded section 34 is inserted into base 36, advertisements directed toward automobiles in the particular price range will be presented to the user.

Of course, the user's characteristics need not result in only the presentation of a targeted advertisement, the user's characteristics can be used to insure that a particular message gets delivered to the device in the form of audio, video, text, etc. While the message can be an advertisement, it is not so limited. For example, the message can be a list of nearby vendors who can accommodate the user's particular needs or a personal message such as electronic mail. Using the above automobile example, rather than be presented with an advertisement paid for by an automobile dealer who sells cars in the user's preferred price range, a message can be provided to the user via home device 18 which provides a list of all automobile vendors in the surrounding area who offer automobiles in the user's preferred price range. Further, the nature of the message, i.e. audio only, graphic display, audio/video and the like which home device 18 is capable of delivering is likewise accommodated.

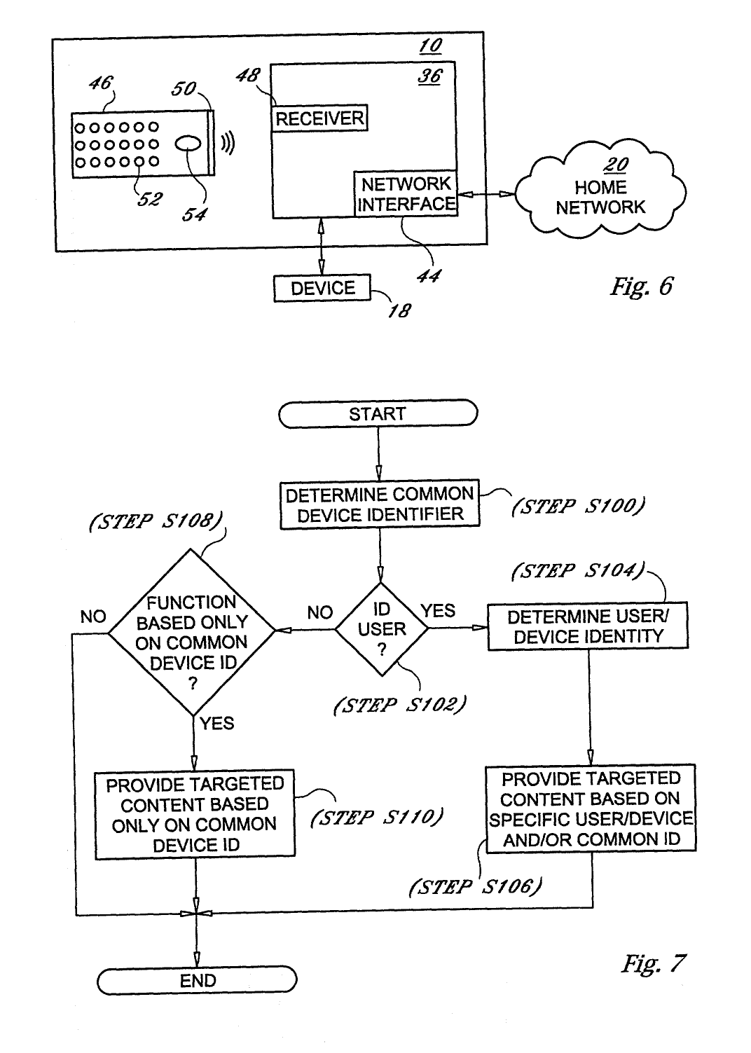

Still another embodiment of apparatus 10 is described with reference to FIG. 6. As shown in FIG. 6, apparatus 10 includes a base unit 36 and a remote control unit 46. Instead of the receptacle and base interface discussed above with respect to the embodiment shown in FIG. 5, the embodiment shown in FIG. 6 includes a receiver 48 arranged to receive a wireless signal such as an infrared or radio frequency signal from transmitter 50 included as part of remote control unit 46.

Remote control unit 46 can be arranged to include one or more function buttons 52 which, when actuated, cause remote controlled unit 46 to transmit a signal via transmitter 50 to receiver 48 within base unit 36 to effect the desired function. Although devices are known which cause a remote control to transmit a signal which when received, causes a particular function to be performed are known, remote control unit 46 also includes identification reader 54. Identification reader 54 is a fingerprint reader or the like which, operating in conjunction with a fingerprint database, allows the user whose fingerprint has been read to be identified.

While an exact match of such fingerprint against a fingerprint database is a method generally known, the invention is not so limited. Rather, in the preferred embodiment a limited number of fingerprint characteristics of the user will be matched against a limited database, such match generating a number reference among a range of numbers sufficient to reasonably differentiate among the number of likely users of remote control unit 46. It is contemplated that such number will be used to generate the UIQ at the time the remote control unit 46 is activated from time to time. Of course, identification reader 54 need not be provided solely as part of remote control unit 46. Identification reader 54 can be provided as part of base unit 36 or device 18. Further, the matching may be performed by any microprocessor contained in any of the devices herein described. It is contemplated that identification reader 54 can be implemented in conjunction with one or more function buttons 52 (not shown), such as a power button such that a UIQ can be generated at the time the user depresses the power button to turn on base unit 36 or home device 18. Of course, identification reader 54 need not be provided solely as part of remote control unit 46. Identification reader 54 can be provided as part of base unit 36.

Remote control unit 46 can be arranged to include a programmable chip 22 (not shown), or programmable chip 22 can be included as part of base unit 36 (not shown) or in identification apparatus 10. In either case, programmable chip 22 is programmed with one or more identification codes or characteristics for one or more users and provides the identification code or user characteristics for the identified user, thereby incorporating the fingerprint database within the encoded chip 22 to avoid the need to provide such database externally. Similarly, programmable chip can be provided directly as part of base unit 36, such as the case where identification reader 54 is provided as part of base unit 36.

Although devices for identifying a person based on his or her fingerprint are known, the present invention implements the identification function not solely to identify the user such as with fingerprint-based security systems, but rather to determine what message, advertisement, etc. to present to the user on home device 18. As discussed above with respect to the embodiment shown in FIG. 5, it is contemplated that the base unit described with respect to FIG. 6 can be included as part of home device 18.

It should be noted that a user need not absolutely be identified by virtue of using identification reader 54. For example, in the case where identification reader 54 is included as part of a function button 52, base unit 36 and/or home device 18 can be programmed to ask the identified user whether his or her identity should be made known for the purposes of providing targeted information such as requested information, messages, advertisements, etc. In other words, the user is given the opportunity to decline to have his or her identity determined and/or made known to computer 32 or any other device accessible via communication network 28.

An advantage to the embodiment shown in FIG. 6 is that, unlike the previously described embodiments, multiple users can use the same remote control unit 46 and still be uniquely identified, such as may occur in a home in which base unit 36 is a cable television or digital satellite converter used by an entire family. In accordance with the present embodiment, each user need not carry an encoded section 34 dedicated solely to that particular user's identification. The same is true with respect to the wired and wireless embodiments shown in FIGS. 1-3.

A method for using the above-described embodiments to enable a user's characteristics and/or specific device to be determined is explained with reference to the flowchart in FIG. 7. The common identifier for home device 18 is determined using a determination process discussed above (step S100). If the user wishes to be identified (step S102), the user is identified and the UIQ determined and/or the home device 18 is identified (step S104) using an above-described process. For example, the identity of home device 18, being the same as every other similar home device with similar capabilities, is initially determined (step S100). By interaction with home network 20 and/or access device 30 and/or through a personal computing device, the user indicates the desire to be identified, the extent of such identification and/or the information which user from time to time is actively seeking. Such information is stored in encoded section 12 or 34 or access device 30. If the user has elected to be identified (step S102) a UIQ is generated by an algorithm which identifies both the nature of the home device 18, and where authorized, information pertaining to the user (step S104). For example, determining the identity of the user or specific device based on the effectively unique identifier encoded section 12 or 34, or directly determining the user's preferences based on user characteristic data stored in encoded section 12 or 34.

Targeted content is provided to the user based on one or more of the common device code and/or the user's preferences (step S106). In the case where the user cannot or does not wish to be identified (step S102), it is contemplated that content based only on the common device code can be provided (step S108). If a system implementing the present invention is not arranged to function based solely on the common device code (step S108), the process ends with no specific content being targeted toward the user of home device 18.

Where a system is arranged to function based only on the determined common device code (step S108) content is provided to the user based only on home device 18 (step S110). With respect to steps S108 and S110, it is contemplated that the use of a common device code alone to determine targeted content is advantageous. For example, a class of devices having the same common device code may be capable of supporting a limited set of functions or have a smaller data storage memory than other similar devices having a different common device code such that knowing the particular type of device is beneficial in determining the nature of the content to send to the device.

For example, a certain class of radios may be capable of storing a limited amount of station presets, while a similar, but more powerful model offered by the same vendor may be capable of storing a significantly greater number of station presets. Although station presets for a particular user could not be stored without knowing the identity and preferences of the particular user, devices having a common identifier can be configured to store a default set of presets. Knowing the differences in capabilities between device classes is useful in determining how many station presets to send to the identified device class.

The present invention advantageously provides an apparatus and method to identify a class of components and a user or particular device using an essentially unique identifier so that particularized content such as messages, advertisements or other information as well as the nature of such content (audio, graphical, video, audio/video etc.) based on the user's characteristics and/or device characteristics as well as user preferences can be determined. This is accomplished by the present invention by employing a common identification code used by devices having a common set of characteristics and/or a separate identifier used to identify the unique device and/or user.

The present invention further advantageously simplifies the process of targeting advertisements by minimizing the interaction between the user and the system such that the user need not maintain a large multitude of profiles for differing devices or be required to constantly update his or her profile.

The identification apparatus provided by the present invention can take the form of a connector between a home device and the communication network so that the user can take the apparatus with him or her to multiple locations. The present invention also provides a highly portable device such as a credit card-like device which a user can conveniently take with him or her for insertion into a compatible base unit. The present invention supports multiple users of a single identification apparatus through the use of a remote-control device which identifies particular users from a group of users, for example using fingerprint identification. In order to protect the user's privacy, the present invention provides each user with the ability to control whether his or her information is made known to remote devices providing targeted content to the user's home device.

It is contemplated that the present invention is applicable to a wide range of networked devices such as cable television converters, digital satellite receivers, cable modems, digital subscriber line modems, network appliances, hand held wireless devices etc., and is compatible with global communication networks, such as the Internet, cellular telephone systems and the like using known data communication protocols such as Transmission Control Protocol/Internet Protocol (TCP/IP).

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A method for using a communication network to determine one or more characteristics, the method comprising:
identifying a device class based on a predetermined common identifier;
identifying an individual apparatus associated with a particular user; and
determining one or more characteristics based on the identified device class and the individual apparatus.

2. The method according to claim 1, wherein the characteristics include device characteristics.

3. The method according to claim 1, wherein the characteristics include user characteristics.

4. The method according to claim 3, wherein the characteristics further include device characteristics.

5. The method according to claim 4, wherein device characteristics and user characteristics are combined to determine an identifier.

6. The method according to claim 4, wherein device characteristics and user characteristics are translated to determine an identifier.

7. The method according to claim 5, wherein the identifier further defines data pertaining to the user.

8. The method according to claim 6, wherein the identifier further defines data pertaining to the user.

9. The method according to claim 3, further comprising:
selecting information based on the determined one or more user characteristics; and
sending the selected information to at least one playing device

10. The method according to claim 9, wherein the information includes at least one advertisement selected by matching at least one user characteristic with at least one characteristic specified by an advertiser, the advertisement capable of being played on a device which is a member of the identified device class.

11. The method according to claim 1, further comprising selecting targeted information based on the common identifier.

12. The method according to claim 3, further comprising:
updating the user characteristics based on the user's exhibited preferences; and
storing the updated characteristics on a portable apparatus.

13. The method according to claim 12, wherein the updated characteristics are stored on a portable apparatus, the method further comprising:
updating the user characteristics based on the user's exhibited preferences; and
storing the updated characteristics on a computing device.

14. The method according to claim 5, further comprising:
updating the user characteristics based on the user's exhibited preferences; and
storing the updated characteristics.

15. The method according to claim 5, further comprising:
updating the user characteristics based on the user's provided preferences; and
storing the updated characteristics.

16. The method according to claim 6, further comprising:
updating the user characteristics based on the user's exhibited preferences; and
storing the updated characteristics.

17. The method according to claim 6, further comprising:
updating the user characteristics based on the user's provided preferences; and
storing the updated characteristics.

18. The method according to claim 1, further comprising providing the user with the opportunity to avoid determining one or more characteristics.

19. An apparatus for identifying one or more characteristics, the apparatus comprising:
a device interface, the device interface being interconnectable with a user device;
an encoded section electrically coupled to the device interface, the encoded section comprising:
an interface section, the interface section being electrically coupled to the device interface and facilitating data communication with a computing device;
an identification component, the identification component being electrically coupled to the interface section and being arranged to identify at least one of a device and a user and provide at least one first identification code associated with the identified at least one of the device and the user to the computing device, the first identification code being evaluatable to determine one or more characteristics.

20. The apparatus according to claim 19, wherein the identification component is a programmable chip.

21. The apparatus according to claim 20, wherein the programmable chip includes an embedded controller further arranged to execute programmatic software code to establish a communication session with the computing device.

22. The apparatus according to claim 19, further comprising a network interface, the network interface being interconnectable with a home network used to communicate with the computing device.

23. The apparatus according to claim 22, wherein the device interface is arranged to transfer a second identification code associated with the device to the computing device.

24. The apparatus according to claim 22, wherein the first identification code and the second identification code are usable to determine one or more characteristics of the user corresponding to the associated device.

25. The apparatus according to claim 22, wherein the network interface is a wireless network interface and the home network is a wireless communication network.

26. An apparatus for identifying one or more characteristics, the apparatus comprising:
a base unit; and
an identification component in data communication with the base unit, the identification component being arranged to identify at least one of a device and a user and provide a first identification code associated with the identified at least one of the device and the user to the base unit, the first identification code being evaluatable to determine one or more characteristics.

27. The apparatus according to claim 26, wherein one or more determined characteristics are pre-established by the user.

28. The apparatus according to claim 26, wherein the identification component is included as part of an encoded section, the encoded section having an interface section to provide the data communication with the base unit.

29. The apparatus according to claim 28, wherein the base unit comprises:
a receptacle for receiving the interface section; and
a base interface arranged to provide electrical and physical connectivity with the interface section when the receptacle has received the interface section.

30. The apparatus according to claim 26, further comprising an identification reader, the identification reader identifying the user from a group of users based on a feature of the user.

31. The apparatus according to claim 30, further comprising a remote control, wherein the identification reader is included as part of the remote control.

32. The apparatus according to claim 31, wherein the remote control includes one or more function buttons, and wherein the identification reader is integrated with one of the one or more function buttons.

33. The apparatus according to claim 26, wherein the base unit further includes a network interface for communicating with a communication network, the first identification code being provided to the communication network through the network interface.

34. The apparatus according to claim 33, wherein the base unit is couplable to a home device.

35. The apparatus according to claim 34, wherein the base unit is integrated as part of the home device.

36. The apparatus according to claim 34, wherein the home device is a television set.

37. The apparatus according to claim 34, wherein the base unit is arranged to provide a second identification code associated with the home device to the communication network.

38. The apparatus according to claim 34, wherein the home device is a cable television converter.

39. The apparatus according to claim 26, wherein the base unit is a cable television converter.

40. The apparatus according to claim 26, wherein the base unit is a digital satellite receiver.
